(19) United States
(12) Patent Application Publication
(10) Pub. No.: US 2012/0104889 A1
(43) Pub. Date: May 3, 2012

(54) Spindle motor

(75) Inventors: Young Tae Kim, Seoul (KR); Jin San Kim, Suwon (KR); Ta Kyoung Lee, Hwaseong (KR)

(73) Assignee: SAMSUNG ELECTRO-MECHANICS CO., LTD, Suwon (KR)

(21) Appl. No.: 13/317,852

(22) Filed: Oct. 31, 2011

(30) Foreign Application Priority Data
Nov. 1, 2010 (KR) 10-2010-0107764

(51) Int. Cl. H02K 7/08

(52) U.S. Cl. 310/90

(57) ABSTRACT

There is provided a spindle motor including: a sleeve including a hollow part having a shaft inserted thereinto and rotatably supporting the shaft; a thrust plate coupled to a lower portion of the shaft in an axial direction to thereby rotate together with the shaft; a cover plate coupled to a lower portion of the sleeve in the axial direction and covering the hollow part; and a step part stepped upwardly from a lower surface of the thrust plate in the axial direction so that the shaft and the thrust plate are easily coupled to each other and having surface roughness greater than that of other portions of the thrust plate.

### CROSS-REFERENCE TO RELATED APPLICATIONS

This application claims the priority of Korean Patent Application No. 10-2010-0107764 filed on Nov. 1, 2010, in the Korean Intellectual Property Office, the disclosure of which is incorporated herein by reference.

### BACKGROUND OF THE INVENTION

1. Field of the Invention

The present invention relates to a spindle motor, and more particularly, to a spindle motor having improved weldability at the time of coupling a shaft to a thrust plate.

2. Description of the Related Art

Generally, a small spindle motor used in a recording disk driving apparatus uses a fluid dynamic bearing assembly. A bearing clearance formed between a shaft and a sleeve of the fluid dynamic bearing assembly is filled with a lubricating fluid such as oil, and fluid dynamic pressure is formed while oil filling the bearing clearance is compressed at the time of rotation of the shaft, and thus the shaft is rotatably supported by the fluid dynamic pressure.

Here, a stopper member may be coupled to the shaft to thereby float a rotor or prevent separation of the rotor. The stopper member may be fixedly coupled to the shaft and have an annular plate shape in which a hole is formed in the center thereof, and the shaft is inserted into the hole. The annular plate may generate fluid dynamic pressure through interaction with the sleeve rotatably supporting the shaft, to thereby serve as a thrust plate.

In a coupling scheme of the thrust plate and the shaft, in the case of a motor having a relatively large size such as 3.5 inches, or the like, according to the related art, sufficient unmating force is secured, such that there is no problem in coupling the thrust plate and the shaft by press-fitting bonding. However, in the case of a motor having a size of 2.5 inches, or the like, in accordance with miniaturization of the motor, coupling force of the thrust plate may not be sufficiently secured with respect to external impact through press-fitting bonding alone.

In order to avoid this problem, a scheme of manufacturing the thrust plate integrally with the shaft and screwing or welding the thrust plate to the shaft may be used.

However, in the case of manufacturing the thrust plate integrally with the shaft, it may be difficult to perform centerless grinding, such that it may be difficult to secure roughness of a shaft surface. In the case of screwing the thrust plate to the shaft, a screw tap needs to be provided in the shaft and a screw thread needs to be provided on the thrust plate, resulting in increased processing costs and a complicated process. In the case of welding the thrust plate to the shaft, when illumination intensity is excessively high in a welded portion, welding properties may be deteriorated due to light reflectivity.

### SUMMARY OF THE INVENTION

An aspect of the present invention provides a spindle motor capable of sufficiently securing coupling force of a thrust plate with respect to an external impact by improving weldability in the case of using a welding method at the time of coupling a shaft to the thrust plate.

According to an aspect of the present inventio, there is provided a spindle motor including: a sleeve including a hollow part having a shaft inserted thereinto and rotatably supporting the shaft; a thrust plate coupled to a lower portion of the shaft in an axial direction to thereby rotate together with the shaft; a cover plate coupled to a lower portion of the sleeve in the axial direction and covering the hollow part; and a step part stepped upwardly from a lower surface of the thrust plate in the axial direction so that the shaft and the thrust plate are easily coupled to each other and having surface roughness greater than that of other portions of the thrust plate.

The step part may have reflectivity lower than that of the other portions of the thrust plate.

The step part may have brightness lower than that of the other portions of the thrust plate.

The step part and the shaft may include a welded part formed therebetween.

An inner portion of the thrust plate in a radial direction may be coupled to the shaft, and an outer portion of the thrust plate in the radial direction may contact the sleeve.

A first thrust dynamic pressure generating groove may be formed in an upper surface of the thrust plate in the axial direction or in a surface of the sleeve facing the upper surface of the thrust plate in the axial direction.

A second thrust dynamic pressure generating groove may be formed in the lower surface of the thrust plate in the axial direction or in a surface of the cover plate facing the lower surface of the thrust plate in the axial direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a spindle motor in an axial direction according to an embodiment of the present invention;

FIG. 2 is an enlarged view of part A of FIG. 1;

FIGS. 3A and 3B are perspective views of a thrust plate in a spindle motor according to an embodiment of the present invention;

FIG. 4 is a perspective view of a sleeve in a spindle motor according to another embodiment of the present invention; and

FIG. 5 is a perspective view of a cover plate in a spindle motor according to another embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the same reference numerals will be used throughout to designate the same or like elements.

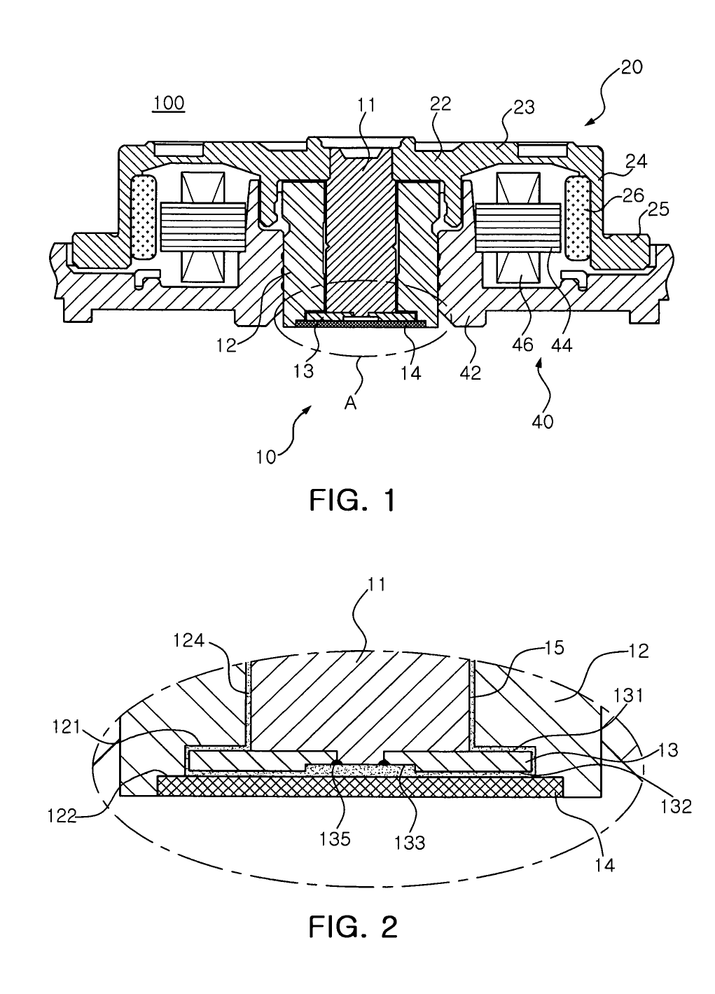

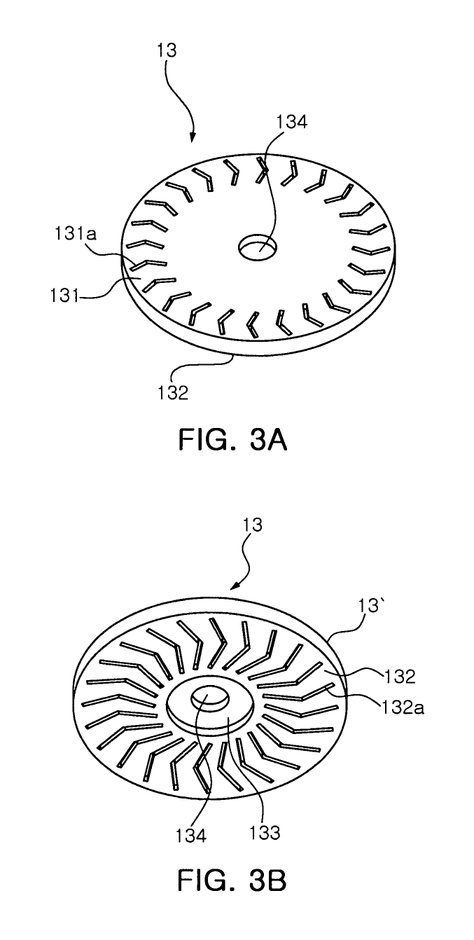

FIG. 1 is a cross-sectional view of a spindle motor in an axial direction according to an embodiment of the present invention; FIG. 2 is an enlarged view of part A of FIG. 1; and FIGS. 3A and 3B are perspective views of a thrust plate in a spindle motor according to an embodiment of the present invention.

Referring to FIGS. 1 through 3, a spindling motor 100 according to an embodiment of the present invention may include a fluid dynamic bearing assembly 10 generating fluid dynamic pressure between a shaft 11 and a sleeve 12, a stator 40 coupled to an outer peripheral portion of the fluid dynamic bearing assembly 10, and a rotor 20 coupled to the shaft 11 to thereby rotate together with the shaft 11.

Meanwhile, terms with respect to directions will be defined. As viewed in FIG. 1, an axial direction refers to a vertical direction based on the shaft 11, and a radial direction refers to a direction toward an outer edge of the rotor 20 based on the shaft 11 or a direction toward the center of the shaft 11 based on the outer edge of the rotor 20.

The fluid dynamic bearing assembly 10 may include the shaft 11, the sleeve 12, a thrust plate 13, and a cover plate 14. Here, the sleeve 12, the thrust plate 13, and the cover plate 14 may be provided as a bearing member.

The shaft 11 is inserted into a hollow part 124 formed at a central portion of the sleeve 12, the thrust plate 13 is disposed at a lower portion of the shaft 11 in the axial direction, and the cover plate 14 is disposed at lower portions of the thrust plate 13 and the sleeve 12 in the axial direction.

Here, oil 15 is filled as lubricating fluid in a micro clearance between an outer peripheral surface of the shaft 11 and an inner peripheral surface of the sleeve 12, and the rotations of a rotating member including the shaft 11 and the rotor 20 may be more smoothly supported by dynamic pressure generated by a radial dynamic pressure generating groove formed in at least one of the outer peripheral surface of the shaft 11 and the inner peripheral surface of the sleeve 12 and having a spiral shape or a herringbone shape.

Here, the sleeve 12 may include a bypass channel (not shown) penetrating through the sleeve so as to communicate between upper and lower portions of the sleeve 12 in the axial direction to thereby distribute oil pressure within the fluid dynamic bearing assembly.

The lower portion of the sleeve 12 in the axial direction may be stepped so that the thrust plate 13 and the cover plate 14 are disposed thereon, and may include a first step part 121 formed so as to contact an outer portion of the thrust plate 13 in the radial direction and a second step part 122 having the cover plate 14 coupled thereto.

The thrust plate 13 may include an insertion hole 134 into which the lower portion of the shaft 11 in the axial direction is inserted and a step part 133 formed so as to be easily coupled to the shaft 11.

An inner portion of the thrust plate 13 in the radial direction is coupled to the lower power of the shaft 11 in the axial direction and an outer portion of the thrust plate 13 in the radial direction is disposed at the first step part 121 formed at the lower portion of the sleeve 12 in the axial direction, such that the thrust plate 13 may serve as a stopper preventing separation of the rotating member including the shaft 11 and the rotor 20 at the time of the rotation of the rotating member.

According to the present embodiment, the thrust plate 13 and the shaft 11 may be coupled to each other by welding, and a welded part 135 may be formed by performing laser welding on a boundary portion between the shaft 11 and the inner portion of the thrust plate 13 in the radial directioin.

The step part 133 may be stepped upwardly from a lower surface of the thrust plate 13 in the axial direction so that the shaft 11 and the thrust plate 13 may be easily coupled to each other, and may have surface roughness greater than that of other portions of the thrust plate 13.

That is, since the welded part 135 is formed at the boundary portion between the step part 133 and the shaft 11 and the step part 133 has surface roughness greater than that of other portions of the thrust plate 13, reflectivity of a laser beam irradiated to the welded part 135 at the time of laser welding is significantly reduced, whereby welding properties between the shaft 11 and the thrust plate 13 may be improved.

The step part 133 may have surface roughness greater than that of other portions of the thrust plate 13 by performing a pressing process at the time of polishing both surfaces of the thrust plate 13. Therefore, it is easy to implement a difference in surface roughness between the step part 133 and the other portions of the thrust plate 13.

Since the step part 133 needs to have laser weldability higher than that of other portions of the thrust plate 13 in the lower surface of the thrust plate 13 in the axial direction, welding properties between the step part 133 and the shaft 11 may be improved by allowing the step part 133 to have greater surface roughness, lower reflectivity, lower brightness, or the like, as compared to the other portions of the thrust plate 13.

A micro clearance between the outer portion of the thrust plate 13 in the radial direction and the first step part 121 of the sleeve 12 is filled with oil 15 as lubricating fluid, and the rotation of the thrust plate 13 may be more smoothly supported by dynamic pressure generated by a first thrust dynamic pressure generating groove 131a formed in an upper surface 131 of the outer portion of the thrust plate 13 in the radial direction.

The first thrust dynamic pressure generating groove 131a in the present embodiment has a herringbone shape; however, the invention is not limited thereto. The first thrust dynamic pressure generating groove 131a may also have a spiral shape. In addition, the first thrust dynamic pressure generating groove 131a in the present embodiment is formed in the upper surface 131 of the outer portion of the thrust plate 13 in the radial direction; however, the invention is not limited thereto. The first thrust dynamic pressure generating groove 131a may also be formed in a surface of the first step part 121 of the sleeve 12 facing the upper surface of the outer portion of the thrust plate 13 in the radial direction.

The cover plate 14 is coupled to the second step part 122 formed at the lower portion of the sleeve 12 in the axial direction and covers the hollow part of the sleeve 12 to thereby support the sleeve 12 and the shaft 11. An outer portion of the cover plate 14 in the radial direction contacts the second step part 122 of the sleeve 12, such that the cover plate 14 may be coupled and fixed thereto, and an upper surface of the cover plate 14 in the axial direction may face the lower surface 132 of the thrust plate 13 in the axial direction.

Oil 15 is received in a clearance between the upper surface of the cover plate 14 in the axial direction and the lower surface 132 of the thrust plate 13 in the axial direction, such that the cover plate 14 itself may serve as a bearing supporting the lower portion of the shaft 11 in the axial direction.

Here, in order to more stably support the rotation of the thrust plate 13 and the shaft 11, a thrust dynamic pressure generating groove may be formed in at least one of the lower surface 132 of the thrust plate 13 in the axial direction and the upper surface of the cover plate 14 in the axial direction. According to the present embodiment, a second thrust dynamic pressure generating groove 132a is formed in the lower surface 132 of the thrust plate 13 in the axial direction.

Similar to the first thrust dynamic pressure generating groove 131a, the second thrust dynamic pressure generating groove 132a may have a spiral shape or a herringbone shape. The second thrust dynamic pressure generating groove 132a in the present embodiment has a herringbone shape.

The rotor 20 is a rotating structure coupled to the shaft 11 to thereby rotate together with the shaft 11 with respect to the stator 40, and may include a rotor case and a magnet 26 mounted on an inner portion of the rotor case.

The rotor case may include a cylindrical part 22 coupled to an outer peripheral surface of the shaft 11, a disk part 23 extended from the cylindrical part 22 outwardly in the radial direction, and a magnet support part 24 bent from an outer portion of the disk part 23 downwardly in the axial direction to thereby support the magnet 26, and a flange 25 extended from a lower portion of the magnet support part 24 outwardly in the radial direction and having a disk mounted thereon.

The magnet 26 may be a permanent magnet generating magnetic force having a predetermined strength by alternately magnetizing N and S poles thereof in the circumferential direction. The rotor 20 rotates by the electromagnetic interaction between a winding coil 46 and the magnet 26.

The stator 40 is a fixed structure including the winding coil 46 generating electromagnetic force having a predetermined magnitude when power is applied thereto and a plurality of cores 44 having the winding coil 46 wound therearound.

The core 44 may be fixedly disposed on an upper portion of a base 42 including a printed circuit board (not shown) having a circuit pattern printed thereon, and the base 42 may include a plurality of coil holes formed to penetrate therethrough in one surface thereof corresponding to the winding coil 46, such that the plurality of coil holes having a predetermined size expose the winding coil 46 downwardly. The winding coil 46 is electrically connected to the printed circuit board so as to receive external power.

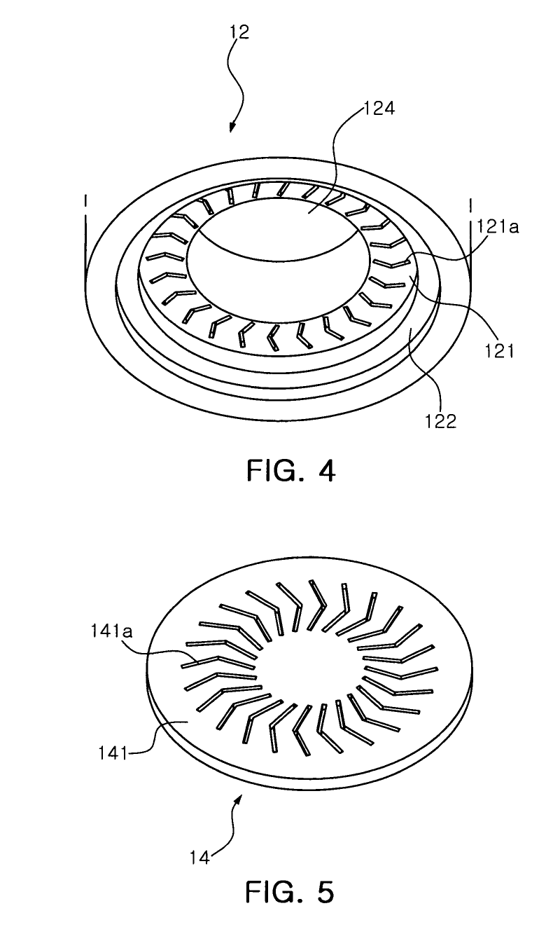

FIG. 4 is a perspective view of a sleeve in a spindle motor according to another embodiment of the present invention; and FIG. 5 is a perspective view of a cover plate in a spindle motor according to another embodiment of the present invention.

FIGS. 4 and 5 show a modified example of a thrust dynamic member in a spindle motor according to another embodiment of the present invention. The other components of this spindle motor are substantially the same as those of the spindle motor according to the embodiment of the invention shown in FIGS. 1 through 3. Therefore, a detailed description thereof will be omitted, and only a difference will be described.

Referring to FIGS. 4 and 5, in the spindle motor according to another embodiment of the invention, a first thrust dynamic pressure generating groove 121a is formed in the first step part 121, which is in contact with the thrust plate in the lower portion of the sleeve 12 in the axial direction, and a second thrust dynamic pressure generating groove 141a is formed in a surface 141 of the cover plate 14 facing the thrust plate.

The first and second thrust dynamic pressure generating grooves 121a and 141a may have a spiral shape or a herringbone shape. In the case in which they have a herringbone shape as shown in the present embodiment, when the thrust plate 13 rotates, lubricating fluid flows from inner and outer portions of the herringbone groove in the radial direction along the herringbone groove toward a central bent portion thereof, and dynamic pressure is generated in an area based on the central bent portion to thereby support a thrust weight of the shaft in the axial direction.

As set forth above, in a spindle motor according to embodiments of the present invention, when a shaft and a thrust plate are coupled to each other through welding, weldability is improved, whereby coupling force of the shaft and the thrust plate with respect to an external impact may be sufficiently secured.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a sleeve including a hollow part having a shaft inserted thereinto and rotatably supporting the shaft;
a thrust plate coupled to a lower portion of the shaft in an axial direction to thereby rotate together with the shaft;
a cover plate coupled to a lower portion of the sleeve in the axial direction and covering the hollow part; and
a step part stepped upwardly from a lower surface of the thrust plate in the axial direction so that the shaft and the thrust plate are easily coupled to each other and having surface roughness greater than that of other portions of the thrust plate.

2. The spindle motor of claim 1, wherein the step part has reflectivity lower than that of the other portions of the thrust plate.

3. The spindle motor of claim 1, wherein the step part has brightness lower than that of the other portions of the thrust plate.

4. The spindle motor of claim 1, wherein the step part and the shaft include a welded part formed therebetween.

5. The spindle motor of claim 1, wherein an inner portion of the thrust plate in a radial direction is coupled to the shaft, and
an outer portion of the thrust plate in the radial direction contacts the sleeve.

6. The spindle motor of claim 1, wherein a first thrust dynamic pressure generating groove is formed in an upper surface of the thrust plate in the axial direction or in a surface of the sleeve facing the upper surface of the thrust plate in the axial direction.

7. The spindle motor of claim 1, wherein a second thrust dynamic pressure generating groove is formed in the lower surface of the thrust plate in the axial direction or in a surface of the cover plate facing the lower surface of the thrust plate in the axial direction.
